(19) United States
(12) Patent Application Publication
(10) Pub. No.: US 2005/0283344 A1
(43) Pub. Date: Dec. 22, 2005

(54) Method and apparatus for matching multiple displays in a multi-display environment

(76) Inventor: Jerry Moscovitch, Toronto (CA)

Correspondence Address: Jerry Moscovitch, 474 Wellington Street West, Toronto, ON, M5V 1E3, CA

(21) Appl. No.: 11/212,643

(22) Filed: Aug. 29, 2005

Related U.S. Application Data
(63) Continuation-in-part of application No. 10/354,867, filed on Jan. 30, 2003.

(51) Int. Cl. G06F 19/00

(52) U.S. Cl. 702/189

(57) ABSTRACT

A method and apparatus for matching at least one visual parameter of multiple displays in a multi-display system environment, the method includes the steps of (a) selecting a visual parameter to be matched; (b) measuring a value associated with the visual parameter in step (a) for a reference display and establishing a reference value; (c) measuring a value associated with the visual parameter in step (a) for another display in the multi-display and establishing a comparative value; (d) comparing the comparative value from step (c) with the reference value from step (b); (e) adjusting the comparative value for the display in step (c) to match the reference value from step (b); and, (f) repeating steps (c)-(e) for any additional displays.

### CROSS-REFERENCE TO RELATED APPLICATION

This application is a continuation-in-part of prior application Ser. No. 10/354,867 filed on Jan. 30, 2003.

### FIELD OF THE INVENTION

This invention relates to multiple displays in a multi-display system environment, generally. In particular, this invention relates to a method and apparatus for matching multiple displays in a multi-display system environment.

### BACKGROUND OF THE INVENTION

The number of multi-display or multi-screen computer systems has increased in recent years as computer users in various industries adapt their use to new environments. For example, a multi-display system can be used to create the illusion of a larger screen, thereby allowing a securities trader to view a large single spreadsheet over several displays. Alternately, the trader may view individual applications on individual screens (for example, one screen may display a Web Browser, a second a new service and a third a spreadsheet of financial data).

Individuals working with still or moving images, such as graphics artists, video or film editors or medical diagnosticians may also use multi-display systems. A given image may be viewed across several screens or two images may be viewed side-by-side (such as two x-ray images used to assess the extent to which a broken bone has healed).

Although the potential uses for multi-display systems appear to be limited only by the user's imagination, there are barriers to their accepted widespread use. A significant barrier is the fact that although individual displays may be manufactured by identical processes using materials that conform to the given manufacturer's specifications, there still are minor variations in manufacturing materials that might result in any two monitors presenting slightly different images to a user, even if the displays have identical display settings. For example, when two displays that are set to the same brightness level are viewed, one display might and often does appear brighter than the other. The potential consequences of these differences range from the merely annoying, to the potentially disastrous depending on the application. For example an individual view in a large spreadsheet or chart over several screens may find that minor color and brightness variations destroy the illusion of continuity between the screens and ultimately of the chart. A medical diagnostician, however, may find that these variations make it more difficult to assess the degree to which a broken bone has healed. This may result in the diagnostician recommending an unnecessary and potentially harmful course of treatment.

Although an individual may manually adjust some display parameters, the ultimate success or failure of any such adjustments rests with the individual's ability to perceive and eliminate these differences. Perception, especially color perception, varies significantly between individuals. As such, manual adjustments based on an individual's perceptions are largely imprecise and time-consuming activities that might not result in the desired end. There remains a need to quickly and precisely match displays in a multi-display system.

### SUMMARY OF THE INVENTION

The present invention provides a method for matching at least one visual parameter of multiple displays in a multi-display system environment, the method includes the steps of (a) selecting a visual parameter to be matched; (b) measuring a value associated with the visual parameter in step (a) for a reference display and establishing a reference value; (c) measuring a value associated with the visual parameter in step (a) for another display in the multi-display and establishing a comparative value; (d) comparing the comparative value from step (c) with the reference value from step (b); (e) adjusting the comparative value for the display in step (c) to match the reference value from step (b); and, (f) repeating steps (c)-(e) for any additional displays.

The measured value is that of the visual parameter as it is presented to a user (i.e., presented value), which has a corresponding setting value that determines the value of the presented value. The presented value is adjusted by adjusting the setting value of the selected visual parameter. The visual parameter may be luminance, contrast, color, hue, chroma or combinations thereof.

The presented value may be user-defined or pre-defined.

The present invention also provides an apparatus for matching at least one visual parameter of multiple displays in a multi-display system environment, which includes a sensor, that is moveable between displays in a multi-display system to detect and measure a value associated with a visual parameter of a reference display and at least one additional display; a memory communicating with the sensor for receiving and storing the measured value of the reference display as a reference value; a comparer communicating with the memory and the sensor for receiving the measured value of the additional display, comparing it to the corresponding stored reference value and generating an adjustment factor; and, an adjuster in communication with the additional display for receiving the adjustment factor and adjusting the value of the compared visual parameter to match the reference value.

The visual parameter detected by the sensor may be luminance, color or combinations thereof.

The adjustment factor is a measure of the difference between the presented value of the reference display and the presented value of the additional display.

Also described herein is a calibration system for calibrating a visual parameter of a plurality of displays in a multi-display system environment. The calibration system includes a sensor capable of being disposed on at least a portion of each of the plurality of displays to detect and measure in each of the plurality a presented value. The calibration system also includes a comparer for comparing presented values to a reference value, and an adjuster for adjusting setting values to thereby calibrate the visual parameter.

### BRIEF DESCRIPTION OF THE DRAWINGS

Preferred embodiments of the present invention are described below with reference to the accompanying drawings in which:

FIG. 1 is a schematic view illustrating a system for matching multiple displays in a multi-display environment according to the present invention;

FIG. 2 is a schematic plan view of a display according to the present invention;

FIG. 3a is a schematic plan view of a sensor displaying a first alternate sensor anchoring means according to the present invention;

FIG. 3b is a schematic plan view of a sensor displaying a second alternate sensor anchoring means according to the present invention;

FIG. 4 is a flow chart view illustrating the steps in a method for matching multiple displays in a multi-display environment according to the present invention;

FIG. 5 is a schematic view illustrating a calibration system for calibrating a visual parameter of a plurality of displays in a multi-display system environment according to one embodiment of the present invention;

FIG. 6 is a schematic bottom view of a sensor of FIG. 5 according to the present invention;

FIG. 7A is a schematic view illustrating a sensor affixed to three-displays in a multi-display system environment according to the present invention;

FIG. 7B shows a schematic bottom view of the sensor of FIG. 7A according to the present invention;

FIG. 8A is a schematic view illustrating a sensor affixed to four displays in a multi-display system environment according to the present invention;

FIG. 8B shows a schematic bottom view of the sensor of FIG. 8A according to the present invention; and

FIGS. 9A-C show respective stages in transforming a two-display sensor into a three-display sensor.

### DETAILED DESCRIPTION

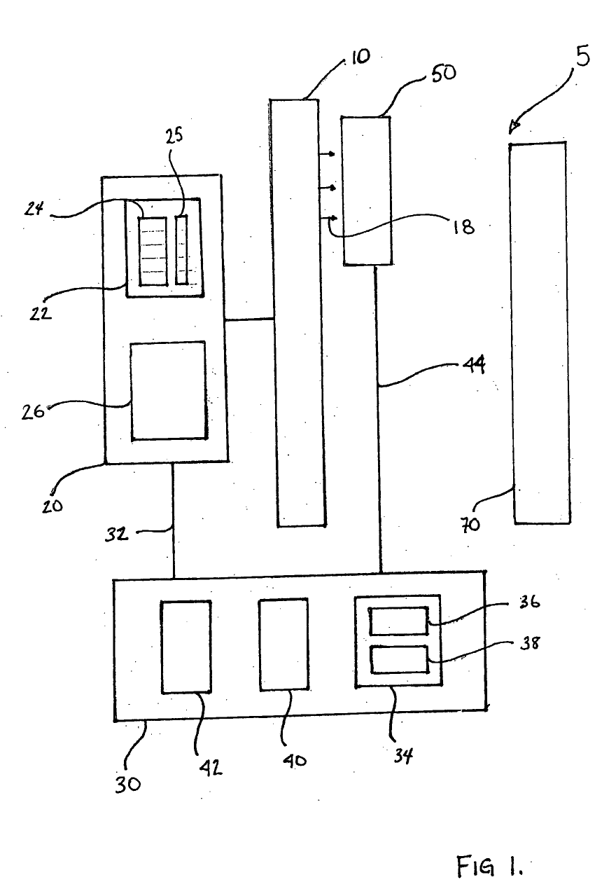

FIG. 1 illustrates a System generally indicated by reference 5 in accordance with a preferred embodiment of the invention.

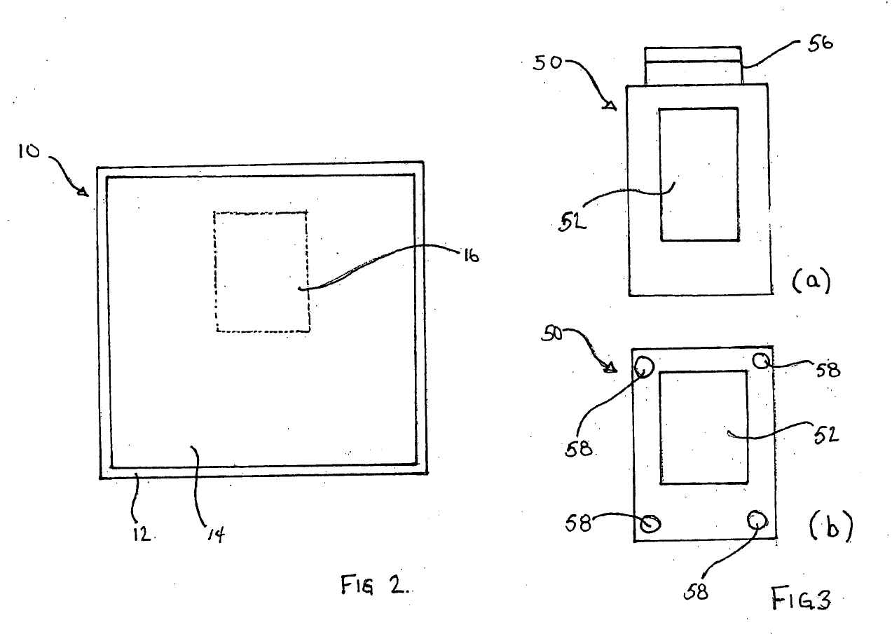

Referring to FIGS. 1, 2 and 3, the System 5 is a system for matching multiple displays in a multi-display system environment comprising a reference monitor or display 10, a monitor or display controller 20, a sensor 50, a sensor controller 30 and at least one additional monitor or display 70. The monitor 10 is preferably an LCD monitor of the type known to those in the art, such as the Model LM181E06 or LM190E02, manufactured by L. G. Phillips LCD of Korea, although any other display known to those in the art may be used. The monitor 10 has a housing 12 surrounding a display area 14. A portion of the display area 14, identified as sensing and measuring area 16, is the portion of the display that is sampled during the matching process.

The quality of the images displayed on the display area 14 is controlled by a display controller 20, which includes at least one Look-Up or Parameter Table 22 and a receiver/writer 26. The Look-Up Table 22 stores a set of visual parameters 24 that define the quality of the displayed images. The visual parameters 24 typically include luminance, contrast and color temperature. Each visual parameter 24 has two corresponding values. The first value is a presented value 18; i.e., the visual parameter 24 as it is presented to a system user. The presented value 18 has a corresponding setting value 25, which largely determines the value of the presented value 18. The setting value 25 for each visual parameter 24 is stored in the Look Up Table 22 of the display controller 20. Accordingly, the presented value 18 is adjusted by adjusting the setting value 25. The presented value 18 is also affected by other factors, such as the quality and physical properties of the display construction materials, for example, slight variations in the conductance properties of the monitor construction materials. As a result, if two displays are set to identical setting values 25, but are constructed of materials with slightly different physical properties, then the quality of the image presented to a user of a multi-display system will vary between monitors; i.e., each monitor will have identical setting values 25, but different presented values 18.

Although a user is able to identify qualitative differences between any two monitors, those differences cannot be readily quantified or resolved without the use of an instrument such as the sensor 50, which is moveable between displays in a multi-display system and configured to detect and measure the presented value 18 associated with a visual parameter 24 of the reference display 10 and at least one additional display 70. The sensor 50 includes a lens or detecting array 52, which detects and quantifies the presented value 18 of any given visual parameter 24 for which it was configured to detect. The sensor 50 is placed over the measuring area 16 of the display 10, with the detecting array 52 facing the measuring area 16.

The sensor 50 may be releasably secured to the display 10 by any releasable securing means known to those in the art, such as a clip 56, which attaches to the display housing 12. Alternately, the sensor 50 may be secured by using suction cups 58, which attach to the display area 14. Any other attachment means for releasably securing the sensor to the display known to those in the art may be employed.

The sensor 50 may be a sensor of the type known to those in the art, such as the SPYDER™, manufactured by ColorVision™ of Rochester, N.Y., U.S.A., or the X-RiteColor Monitor Optimizer™, manufactured by X-Rite, Inc. of Grandville, Mich., U.S.A. Alternately, any means for sensing, moveable between displays in a multi-display system, for detecting and measuring a value associated with a visual parameter of a reference display and at least one additional display may be employed.

The sensor 50 is controlled by a sensor controller 30, which includes a memory 34 for storing the presented visual parameter values as detected and measured by the sensor 50.

The memory 34 communicates with the sensor 50 and receives and stores the measured value of the reference display as a reference value.

The memory 34 is a non-volatile computer readable memory of the type known to those in the art. The measured values that memory 34 stores include a reference value 36 and a comparative value 38. The reference value 36 is the standard presented value 18 for any given visual parameter 24 against which all comparative values 38 are measured. Alternately, any means for storing the measured value of the reference display as a reference value may be employed.

The reference value 36 may be user-defined or pre-defined. For example, if color is the selected visual parameter, then a color reference used may be that as defined by the International Color Consortium (Specification ICC.1:2001-12; http://www.color.org).

The comparer 40 communicates with the memory 34 and the sensor 50 for receiving the measured value of the additional display 38, comparing it to the corresponding stored reference value 36 and generating an adjustment factor. Sensor controller 30 also includes a comparer 40, which compares the stored reference value 36 to its corresponding comparative value 38 and generates an adjustment factor by which the visual parameter's setting value should be adjusted so that the comparative presented visual parameter 38 is substantially identical to the stored reference value 36. The adjustment factor is a measure of the difference between the presented value of the reference display and the presented value of the additional display.

The comparer 40 may be a sub-routine of the matching system, or a stand-alone application that interacts with the sensor 50, memory 34 and adjuster 42. Alternately, any means for comparing the measured value of the additional display to the corresponding stored reference value and generating an adjustment factor known to those skilled in the art may be employed.

The adjustment factor is taken by an adjuster 42, which in turn transmits the adjustment factor to receiver/writer 26 of the display controller 20 via communication link 32. Receiver/writer 26 then adjusts the setting value 25 of the Look Up Table 22 so that the corresponding presented value 18 matches the reference value 36 for the given visual parameter 24. The adjuster 42 may be a sub-routine of the matching system, or a stand-alone application that interacts with the display controller 20 and comparer 40. The adjuster 42 communicates with the additional display for receiving the adjustment factor and adjusting the value of the compared visual parameter 38 to match the reference value 36. Alternately, any means for adjusting the value of the compared visual parameter to match the reference value may be employed.

The sensor 50, memory 34, comparer 40 and adjuster 42 together comprise an apparatus for matching at least one visual parameter of multiple displays in a multi-display system environment. In a preferred embodiment, the apparatus is housed in a single unit. In an alternate embodiment, the components of the apparatus are distributed throughout the multi-display system environment.

Method of Matching:

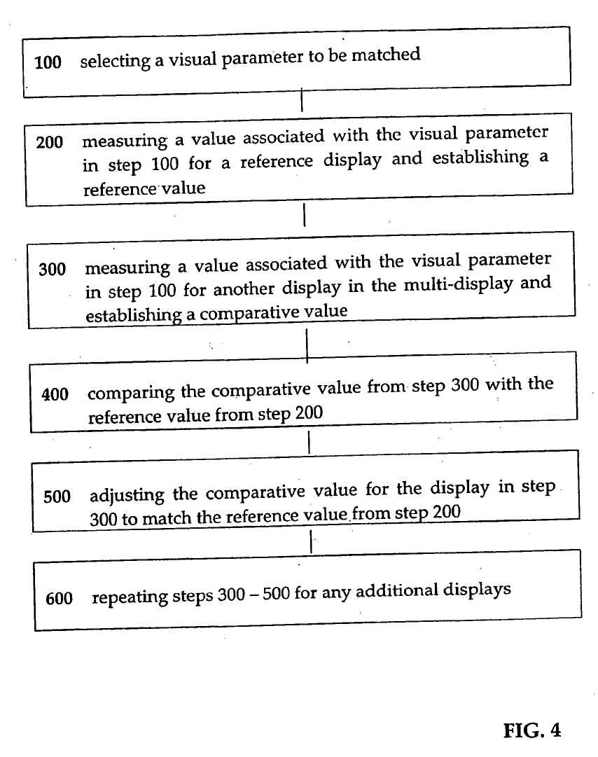

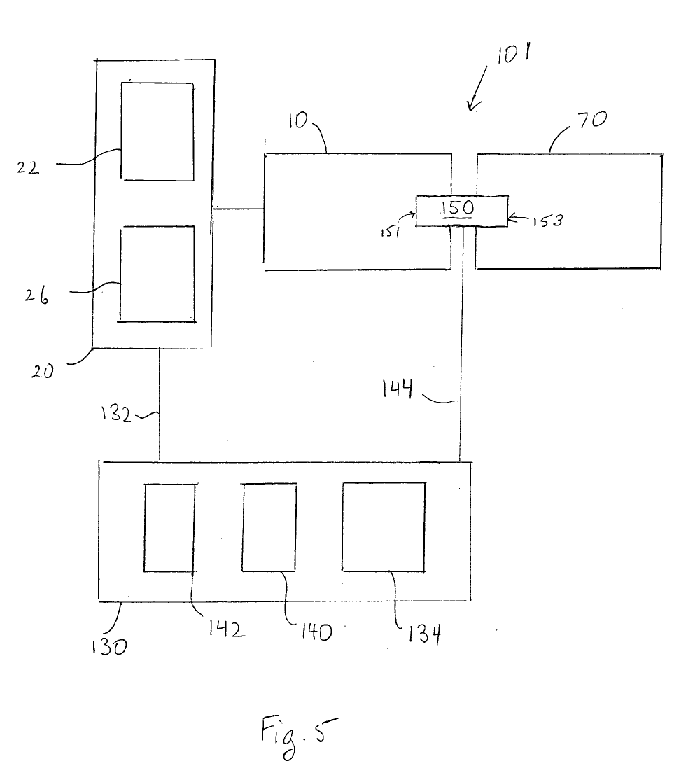

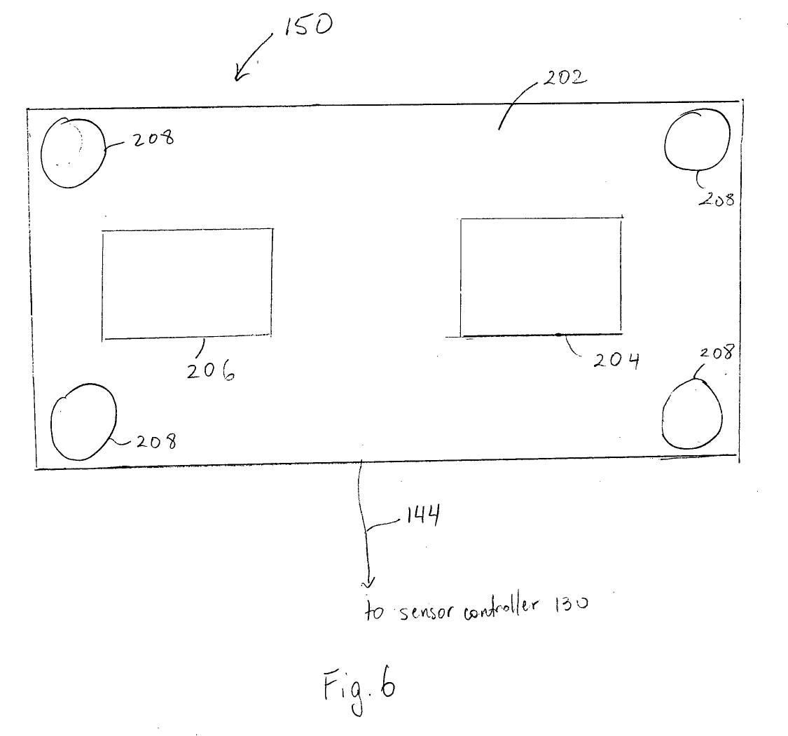

A method of matching at least one visual parameter of multiple displays in a multi-display system environment according to one embodiment of the present invention will now be discussed with reference to FIGS. 1 and 4. Beginning at step 100, a visual parameter to be matched is selected. The visual parameter may be luminance, contrast, color or combinations thereof. Once the visual parameter or combination of visual parameters is selected, then at step 200 a presented value 18 associated with the visual parameter selected in step 100 is selected as a reference value 36.

In a preferred embodiment, a user using the sensor controller 30 invokes an on-screen display menu and selects a calibrate sub-menu. A test signal is generated and the user is prompted to place the sensor 50 over the sensing area 16 of the display 10. The sensor 50 communicates with the sensor controller 30 via sensor communication link 44, which may be either a wired or wireless connection. The sensor controller in turn communicates with display controller 20 via display communication link 32, which may also be a wired or wireless connection. The user is then prompted to calibrate the display 10 visual parameters. This may be done automatically or manually through either a pre-defined or user-defined set of visual parameter values. When the calibration is complete, the display's 10 visual parameter profile is stored in the memory 34 as reference value 36. The setting values 25 of Look Up Table 22 are also updated by receiver/writer 26 in the display controller 20 to reproduce the reference visual parameter profile. The memory 34 may store any number of reference values 36 and reference visual parameters as is required by the user's system needs.

At step 300, a presented value 18 associated with the visual parameter 24 selected in step 100 is measured for another display 70 in the multi-display environment and a comparative value 38 is generated. In a preferred embodiment, to match the visual parameter profiles of an additional display 70 to the reference visual parameter profile, a user using the sensor controller 30 invokes an on-screen display and selects a Match sub-menu. A test signal is generated and the user is prompted to place the sensor 50 over a sensing area of the additional display 70. The sensor 50 communicates with the sensor controller 30 via sensor communication link 44 and transmits the additional display visual parameter profile to the memory 34 as comparative value 38.

At step 400, a comparer 40 compares the comparative value 38 with the reference value 36 and an adjustment factor is generated. Once the adjustment factor is generated, the adjuster 42 communicates with the receiver/writer 26 of display controller 20 via communication link 32 to adjust the setting value 25 of the selected visual parameter 24 such that its presented value 18 matches the reference value 36 for the given visual parameter. At step 600, steps 300 to 500 are repeated for any additional displays in the multi-display system.

In an alternate embodiment step 200 includes the additional steps of selecting a presented value 18 to which the visual parameter 24 in step 100 is to be set; and, adjusting the setting value 25 of the visual parameter 24 of the reference display 10 so that the selected presented value 18 is presented.

In a further alternate embodiment step 500 includes the additional steps of adjusting the setting value 25 of the additional display 70 so that its presented value matches the presented value 18 of the reference display 10.

In an alternate embodiment, the reference value 36 of memory 34 may be stored in other memory stores, such as a centrally located network memory store, as central reference value. The central reference value may then be accessed by any remote multi-display system and stored in the local memory of each system. The presented values of the remote multi-display systems may then be matched to the central reference value. In an alternate embodiment, the reference values 36 are incorporated into a network user's network profile as a profile reference value. As the network user logs on to any given multi-display system in a networked environment, the given multi-display system's presented values will be matched to the profile reference value included in the user's profile.

In a further alternate embodiment, sensor 50 and sensor controller 30, which includes the memory 34 and the reference values 36, are physically moved from system 5 and incorporated into a remote multi-display system. Once incorporated, the remote multi-display system presented values may be matched to the reference value 36.

In another embodiment of the present invention, a sensor is disposed on at least a portion of each of a plurality of displays. Once so disposed, the sensor is configured to detect and quantify a selected visual parameter. Advantageously, such a sensor need only be positioned in one place only once during the complete calibration process instead of having to be moved from display to display, thereby simplifying the calibration process.

FIG. 5 shows a calibration system 101 having such a sensor 150 for calibrating a visual parameter of a plurality of displays in a multi-display system environment. The calibration system 101 includes the sensor 150 in communication, via a sensor communication link 144, with a sensor controller 130 having a memory 134, a comparer 140 and an adjuster 142. The sensor controller 130 is also in communication, via a communication link 132, with the monitor controller 20. The sensor 150 is disposed on a first portion 151 of the first monitor or display 10 and on a second portion 153 of the second monitor or display 70.

The sensor 150 detects and measures in each of the plurality a presented value associated with a selected value of the visual parameter. The visual parameter can, for example, be one of luminance, color, contrast or combinations thereof. For instance, if the visual parameter is color, the selected value, which can be pre-defined or user-defined, can represent the color red. The presented value corresponds to the actual value of the visual parameter that is manifest on a display. Because of physical variances of displays, the color represented by the selected value may not be the same as the color represented by the presented value, and, moreover, for the same selected value, each display may manifest different presented values. The calibration system 101 functions to rectify these discrepancies by calibrating the plurality of displays in the multi-display system environment.

The comparer 140 compares presented values to a reference value. As detailed below, the reference value can be that of one particular display chosen as a reference (display 10, for example), or of a third party standard, such as that of the ICC. The adjuster 142 adjusts setting values associated with the selected value to thereby calibrate the visual parameter.

The sensor controller 130 prompts the display controller 20 to send signals to each of the plurality of displays corresponding to a particular selected value of a visual parameter. For example, if the visual parameter is color, the selected value may be a number that represents a particular red color. (More generally, the selected value for each display need not represent the same color; in other words, different values can be selected for the different displays.) For example, the Commission Internationale de l'Eclairage (CIE) numbering system that specifies a color using three coordinates may be used.

To the selected value there corresponds an associated setting value for each of the displays, as determined by the LUT 22. When the setting value is chosen, a presented value becomes manifest on the display. The presented value is indicative of the color presented on a display. The presented value can be a number representing the characteristics of the electromagnetic wave emitted from the display that is responsible for creating the impression of color. Thus, based on the selected value, a setting value is processed that gives rise to a presented value.

For aforementioned reasons, such as manufacturing variances, the color represented by the presented value may not be the same as the color represented by the selected value. In the above example, the presented value may represent orange even though the selected value represents red. Moreover, the same selected value may result in different presented values in the plurality of displays.

There are two ways to calibrate the displays. A reference display may be taken to be the standard with respect to which all the remaining displays are compared by the comparer 140 and calibrated. Alternatively, all of the displays may be calibrated with respect to a universal reference, such as that of the ICC.

In the first method of calibration, a pre-defined or user-defined selected value is chosen for a reference display, such as the display 10. The presented value of the reference display becomes the reference value, which is stored in the memory 134 and compared by the comparer 140 to the presented values of the remaining displays, which in FIG. 5 is display 70. The LUT 22 is modified by the adjuster 142 by adjusting the setting values of the non-reference displays. When this first method of calibration is performed, the resultant presented values are the same in all of the displays when the same selected value is chosen for each of the displays. However, the color represented by the selected value (red, in the above example) may not agree with the color represented by the presented values in the displays. For example, if the color (e.g., orange) represented by the presented value of the reference display before calibration is not the same as the color represented by the selected value (red), then after calibration all displays will produce the same color orange when the selected value represents the color red.

In a second method of calibration, no display is singled out to be a reference. Instead, the presented values of all the displays are compared by the comparer 140 to a reference value stored in the memory 134 of the sensor controller 130. The reference value may agree with a widely used standard, such as that of the ICC. The LUT 22 is modified by the adjuster 142 by adjusting the setting values of all the displays, if needed. When this second method of calibration is performed, the resultant color represented by the presented values is the same in all of the displays when the same selected value is chosen for each of the displays. In addition, the color represented by the selected value (red, in the above example) agrees with the color represented by the presented values of the displays.

FIG. 6 shows a bottom view of the sensor 150 of FIG. 5. The side shown in this view is the one that is in contact with the faces of the displays. The sensor 150 includes a backing 202 to which are affixed two light receptor units 204, 206, one for each of the two displays 10 and 70 of FIG. 5. Affixing units 208, such as suction cups, are provided to affix the sensor 150 to the faces of the displays 10 and 70. Other affixing means, such as clips, may also be used. In some embodiments, affixing means can be lacking; in such case, the sensor may be disposed on the displays “by hand.” The backing 202 can be made of a flexible material to accommodate various display geometries in which the displays 10 and 70 do not lie on the same plane.

In operation, the first light receptor unit 204 is disposed over the first portion 151 of the display 10. The second light receptor unit 206 is disposed over the second portion 153 of the display 70. The first light receptor unit 204 receives light emitted from the display 10 and the second light receptor unit 206 receives light emitted from the second display 70. Information related to the characteristics of the light emitted by the first display 10 and the second display 70 is transmitted to the sensor controller 130 via the sensor communication link 144. If the visual parameter to be calibrated is color, the sensor controller 130 performs a colorimetric analysis for calibrating the displays 10 and 70. Other types of analyses can be correspondingly performed if the visual parameter is luminance or contrast.

It should be understood that the sensor 150 could be used to calibrate two displays in a multi-display system environment containing more than two displays, so long as portions of the two displays can be made to appropriately overlap with the sensor 150. In addition, in other embodiments, the light receptor units 204 and 206 can be contiguous on the backing 202.

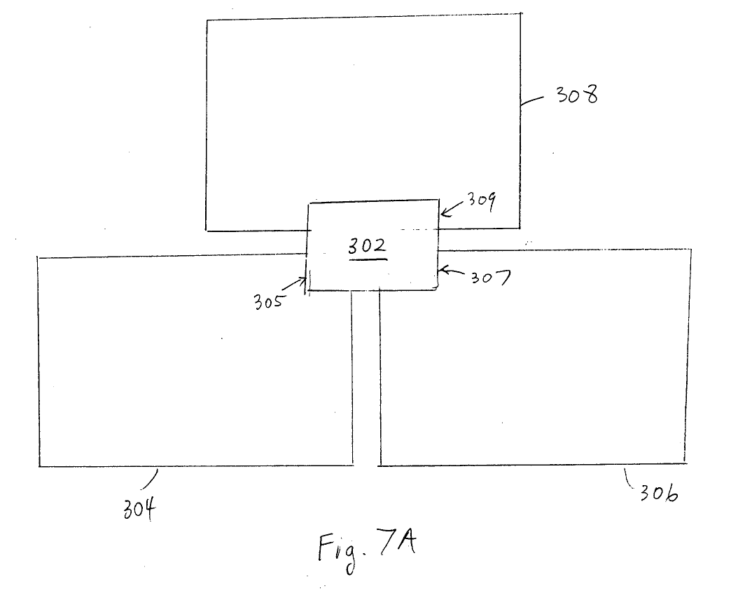

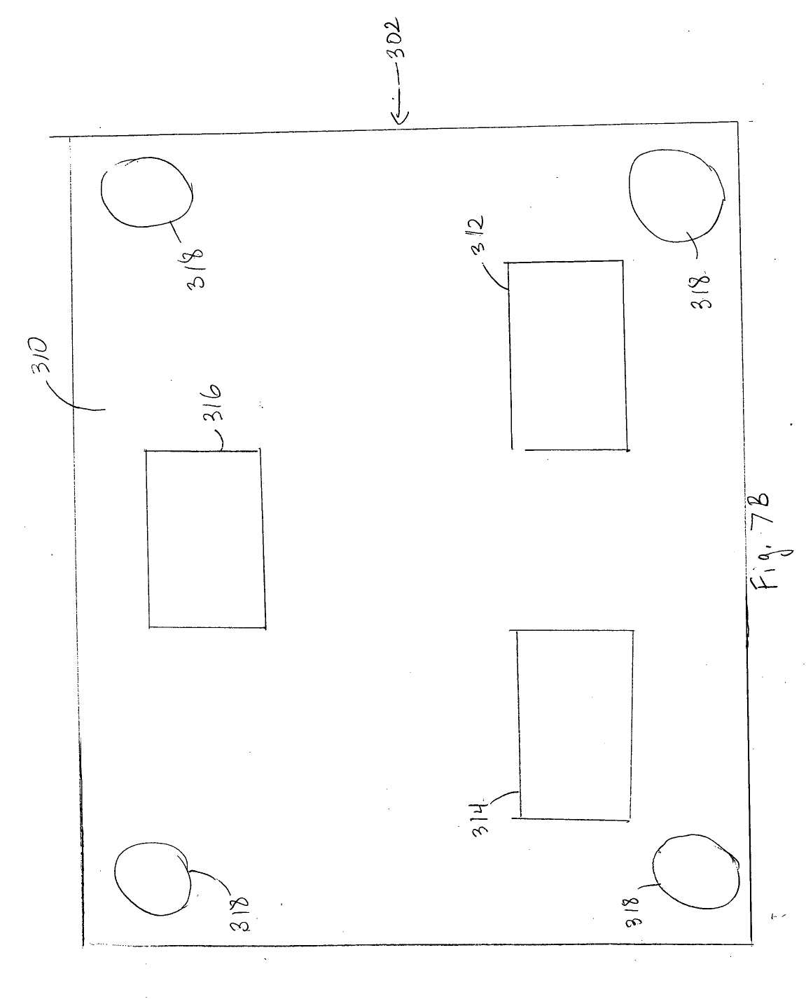

Sensors with more than two light receiving units are also consistent with the principles of the present invention. FIG. 7A shows a sensor 302 disposed on three displays 304, 306 and 308 in a multi-display system environment. The sensor 302 forms part of a calibration system most of whose elements are omitted in FIG. 7A because they correspond to those shown and described above with reference to FIG. 5. The sensor 302 overlaps a first portion 305 of the display 304, a second portion 307 of the display 306 and a third portion 309 of the display 308.

FIG. 7B shows a bottom view of the sensor 302. The side shown in this view is the one that is in contact with the faces of the displays. The sensor 302 includes a backing 310 to which are affixed three light receptor units 312, 314, and 316, one for each of the three displays 304, 306 and 308 of FIG. 7A. Affixing units 318, such as suction cups, are provided to affix the sensor 302 to the front of the displays 304, 306 and 308. Other affixing means, such as clips, may also be used. The backing 310 can be made of a flexible material to accommodate various display geometries in which the displays 304, 306 and 308 do not lie on the same plane.

In operation, the first light receptor unit 312 is disposed over the first portion 305 of the display 304. The second light receptor unit 314 is disposed over the second portion 307 of the display 306. The third light receptor unit 316 is disposed over the third portion 309 of the display 308. The first light receptor unit 312 receives light emitted from the display 304, the second light receptor unit 314 receives light emitted from the second display 306, and the third light receptor unit 316 receives light emitted from the third display 308. Information related to the characteristics of the light emitted by the first display 304, the second display 306 and the third display 308 are transmitted to a corresponding sensor controller (not shown in FIG. 7A or 7B). If the visual parameter to be calibrated is color, the sensor controller performs a colorimetric analysis for calibrating the displays 304, 306 and 308. Other types of analyses can be correspondingly performed if the visual parameter is luminance or contrast.

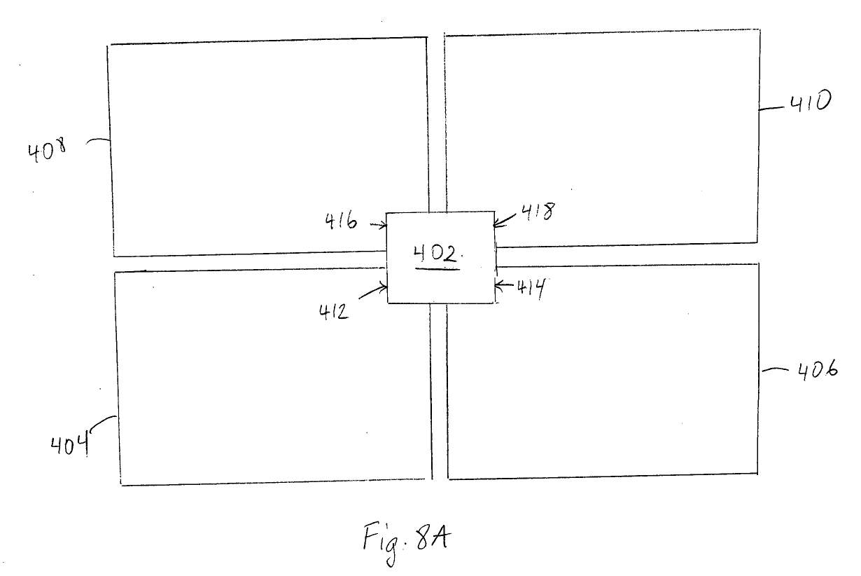

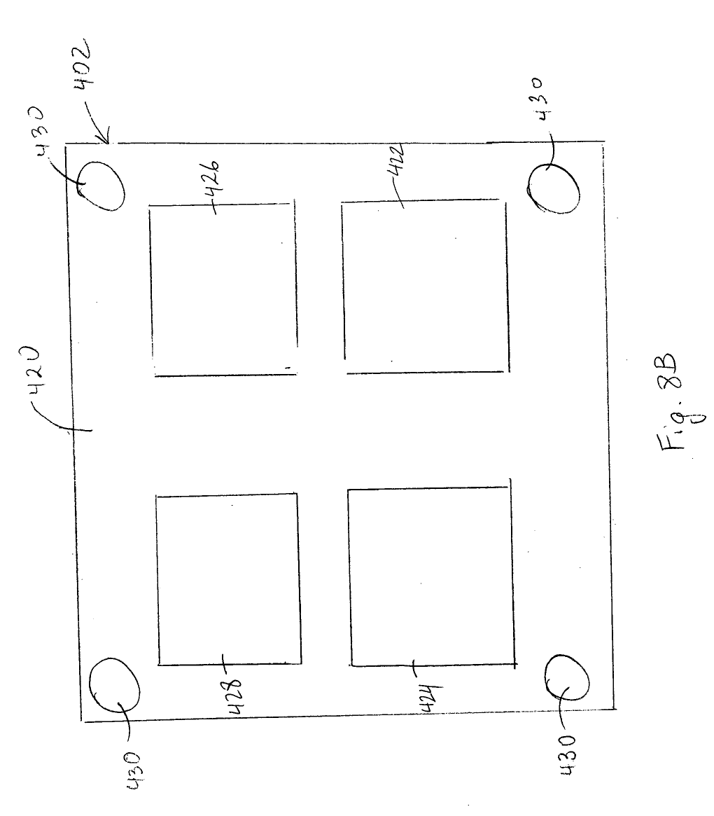

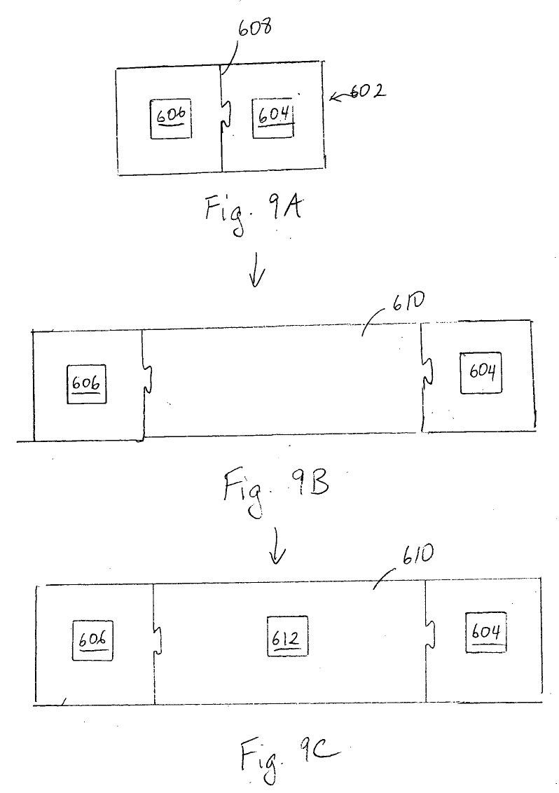

FIG. 8A shows a sensor 402 disposed on four displays 404, 406, 408 and 410 in a multi-display system environment. The sensor 402 forms part of a calibration system most of whose elements are omitted in FIG. 8A because they correspond to those shown and described above with reference to FIG. 5. The sensor 402 overlaps a first portion 412 of the display 404, a second portion 414 of the display 406, a third portion 416 of the display 408, and a fourth portion 418 of the display 410.

FIG. 8B shows a bottom view of the sensor 402. The side shown in this view is the one that is in contact with the faces of the displays. The sensor 402 includes a backing 420 to which are affixed four light receptor units 422, 424, 426 and 428, one for each of the four displays 404, 406, 408 and 410 of FIG. 8A. Affixing units 430, such as suction cups, are provided to affix the sensor 402 to the front of the displays 404, 406, 408 and 410. Other affixing means, such as clips, may also be used. The backing 420 can be made of a flexible material to accommodate various display geometries in which the displays 404, 406, 408 and 410 do not lie on the same plane.

In operation, the first light receptor unit 422 is disposed over the first portion 412 of the display 404. The second light receptor unit 424 is disposed over the second portion 414 of the display 406. The third light receptor unit 426 is disposed over the third portion 416 of the display 408. The fourth light receptor unit 428 is disposed over the fourth portion 418 of the display 410. The first light receptor unit 422 receives light emitted from the display 404, the second light receptor unit 424 receives light emitted from the second display 406, the third light receptor unit 426 receives light emitted from the third display 408 and the fourth light receptor unit 428 receives light emitted from the display 410. Information related to the characteristics of the light emitted by the first display 404, the second display 406, the third display 408 and the fourth 410 display are transmitted to a corresponding sensor controller (not shown in FIG. 8A or 8B). If the visual parameter to be calibrated is color, the sensor controller performs a calorimetric analysis for calibrating the displays 404, 406, 408 and 410. Other types of analyses can be correspondingly performed if the visual parameter is luminance or contrast.

The light receptor units may be designed to be moveable with respect to the backing. For example, the light receptor units could move along rails on the backing. In another embodiment, the light receptor units could be removably affixed to the backing, such as with Velcro™ or clips. Moveable light receptors can be used to accommodate various multi-display geometries. For example, the sensor 150 could be easily modified to coincide with the sensor 302. For this purpose, the two light receptors 204 and 206 could be snapped off the backing and rearranged on the backing 202. A third light receptor could then be added to the backing to produce the sensor 302. In addition, moveable light receptors are useful to accommodate various widths between displays. Removable light receptors can also make storage of the sensors more convenient. Thus, the light receptors can be removed from the backing and stored in a safe location, together with the backing, which might be foldable to aid in storage. A foldable backing can also be used even when the light receptors cannot or are not removed. For example, the backing 202 can be made foldable along a vertical line in the center of the sensor. In this manner, the horizontal length of the sensor 202 can be halved for storage.

In yet another embodiment, the backing itself may be extendible to accommodate various display geometries. For example, the backing can have a sliding member that allows the length or height of the backing to change. Or alternatively, the backing can be constructed from modular pieces that allow the shape or size of the backing to change by adding or removing pieces. Such a modular arrangement could be useful in a three-display system environment where the displays are arranged horizontally, instead of in the pyramid shape of FIG. 7A.

A sensor such as the sensor 202 could be modified to accommodate such a geometry if the backing is modularly configurable. Referring to FIGS. 9A-9C, a sensor 602, similar to the sensor 202, having two light receptors 604 and 606, could be adapted to snap into two pieces along a center vertical line 608. A center extension 610 could then be added so that the resulting backing spans the three displays. A third light receptor unit 612 would then be added appropriately. Any suitable means to attach the two halves of the sensor 602 and the extension 610 could be employed, such as Velcro™, clips, and mating members. The affixing means (not shown in FIG. 9A-9C) that are used to secure the sensor to the displays, such as affixing means 208, can also be removable from the backing, and extra affixing means may also be added to the backing as required.

Many or all of the aforementioned steps for calibrating can be automated. Thus, a user may open an application that prompts the user to affix the sensor to the displays, but which otherwise automatically controls the calibration. For example, the selected values to calibrate may automatically be used based on pre-defined values.

The present invention is defined by the claims appended hereto, with the foregoing description being illustrative of the preferred embodiments of the invention. Those of ordinary skill may envisage certain additions, deletions and/or modifications to the described embodiments, which, although not explicitly suggested herein, do not depart from the scope of the invention, as defined by the appended claims.

1. A method for matching at least one visual parameter of multiple displays in a multi-display system environment, including the steps of:
(a) selecting a visual parameter to be matched;
(b) placing a sensor on at least a portion of each of the multiple displays, said sensor configured to detect and quantify the selected visual parameter;
(c) measuring with the sensor a value associated with the visual parameter in step (a) for a reference display and establishing a reference value;
(d) measuring with the sensor a value associated with the visual parameter in step (a) for another display in the multi-display and establishing a comparative value;
(e) comparing the comparative value from step (c) with the reference value from step (b);
(f) adjusting the comparative value for the display in step (c) to match the reference value from step (b); and
(g) repeating steps (d)-(f) for any additional displays.

2. The method of claim 1, wherein the measured value of steps (c) and (d) is that of the visual parameter as it is presented to a user and the presented value has a corresponding setting value, which determines the value of the presented value.

3. The method of claim 2, wherein the presented value is adjusted by adjusting the setting value of the selected visual parameter.

4. The method of claim 3, wherein step (c) includes the additional steps of:
(c-i) selecting a presented value to which the visual parameter in step (a) is to be set; and
(c-ii) adjusting the setting value of the visual parameter of the reference display so that the selected presented value is presented.

5. The method of claim 3, wherein step (f) includes the additional steps of adjusting the setting value of the other display so that its presented value matches the presented value of the reference display.

6. The method of claim 2, wherein the presented value is user-defined.

7. The method of claim 2, wherein the presented value is pre-defined.

8. The method of claim 1, wherein the display is an LCD monitor.

9. The method of claim 1, wherein the visual parameter is a member selected from the group consisting of luminance, contrast, color and combinations thereof.

10. The method of claim 9, wherein the measured value of steps (c) and (d) is stored in a non-volatile computer readable memory.

11. The method of claim 10, wherein the non-volatile computer readable memory is located at a location remote from the sensor.

12. The method of claim 2, wherein the setting value is stored in a display controller.

14. An apparatus for matching at least one visual parameter of multiple displays consisting of a reference display and at least one additional display in a multi-display system environment, including:
a. a sensor capable of being disposed on at least a portion of each of the multiple displays to detect and measure a value associated with a visual parameter of the reference display and the at least one additional display;
b. a memory communicating with the sensor for receiving and storing the measured value of the reference display as a reference value;
c. a comparer communicating with the memory and the sensor for receiving the measured value of the additional display, comparing it to the corresponding stored reference value and generating an adjustment factor; and
d. an adjuster in communication with the additional display for receiving the adjustment factor and adjusting the value of the compared visual parameter to match the reference value.

15. The apparatus of claim 14, wherein the visual parameter is a member selected from the group consisting of luminance, contrast, color and combinations thereof.

16. The apparatus of claim 14, wherein the sensor further includes an attachment means for releasably securing the sensor to the multiple displays.

17. The apparatus of claim 14, wherein the measured value is that of the visual parameter as it is presented to a user and the presented value has a corresponding setting value, which determines the value of the presented value.

18. The apparatus of claim 17, wherein the presented value is adjusted by adjusting the setting value of the selected visual parameter.

19. The apparatus of claim 18, wherein the setting value is stored in a memory of a display controller.

20. The apparatus of claim 19, wherein the adjuster adjusts the setting value of the additional display.

21. The apparatus of claim 14, wherein the memory is a non-volatile computer readable memory.

22. The apparatus of claim 14, wherein the non-volatile computer readable memory is located at a location remote from the sensor.

23. The apparatus of claim 14, wherein the adjustment factor is a measure of the difference between the presented value of the reference display and the presented value of the additional display.

24. A calibration system for calibrating a visual parameter of a plurality of displays in a multi-display system environment, the calibration system comprising
a. a sensor capable of being disposed on at least a portion of each of the plurality of displays to detect and measure in each of the plurality a presented value;
b. a comparer for comparing presented values to a reference value; and
c. an adjuster for adjusting setting values to thereby calibrate the visual parameter.

25. The calibration system of claim 24, wherein the sensor includes
a backing; and
light receptor units removably attached to the backing, the light receptor units capable of receiving light to detect and measure presented values of the visual parameter.
